(19) United States
(12) Patent Application Publication
(10) Pub. No.: US 2015/0380955 A1
(43) Pub. Date: Dec. 31, 2015

(54) PORTABLE ELECTRONIC POWER SOURCE FOR AIRCRAFT

(71) Applicant: Aviation Battery Systems LLC, Chandler, AZ (US)

(72) Inventors: Scott URSCHEL, Chandler, AZ (US); Todd PETERSEN, Chandler, AZ (US)

(21) Appl. No.: 14/811,930

(22) Filed: Jul. 29, 2015

Related U.S. Application Data
(63) Continuation-in-part of application No. 13/750,295, filed on Jan. 25, 2013.

(51) Int. Cl. H02J 7/00; H01R 27/02

(52) U.S. Cl. CPC H02J 7/007; H01R 27/02; H02J 7/0045; H02J 7/0047; H02J 2007/005

(57) ABSTRACT

The present invention is a ground power unit for aircraft. The ground power unit includes a battery and a standardized aircraft ground power connector. The ground power unit also comprises a means for recharging the battery of the ground power unit. In some embodiments of the invention, the means for recharging the battery may also be adapted to provide power to an aircraft electrical system to which the ground power unit is connected.

### CROSS-REFERENCE TO RELATED APPLICATION

This application is a continuation in part of U.S. patent application Ser. No. 13/750,295 entitled PORTABLE ELECTRIC POWER SOURCE FOR AIRCRAFT filed on Jan. 25, 2013 and is hereby incorporated by reference in its entirety herein.

### TECHNICAL FIELD

Exemplary embodiments of the present invention relate generally to aircraft and aircraft services, portable power supplies, and in particular to ground support equipment and emergency apparatus used for starting aircraft.

### BACKGROUND AND SUMMARY OF THE INVENTION

As was described in U.S. patent application Ser. No. 13/750,295, known technology used to start an aircraft includes wheeled cart devices positioned near an aircraft to be started by a ground crew and connected to the aircraft to be started. Such devices are commonly referred to as ground power units (“GPU”s). After starting the aircraft, the GPU is disconnected from the aircraft and wheeled away for storage. As was noted in the reference patent application, a concern for pilots, particularly for pilots of helicopters is starting the aircraft at remote locations. Because such remote locations may not have access to a GPU, particularly if the remote location is not an airfield, as is frequently the case with helicopters, a pilot may have to rely on the aircraft primary battery to restart the engine. Should the primary battery not have enough capacity to start the engine, the aircraft may be stranded until help arrives. As was noted in the earlier filed application, portable ground power units are known but these units are bulky and heavy and as a result, may be difficult to transport in aircraft with limited storage and cargo capacity. Application Ser. No. 13/750,295 disclosed and claimed a compact ground power unit that eliminated the need for separate power cables by incorporating a connector used to connect the ground power unit to the electrical system of the aircraft. As was illustrated, such a connector may be a multiple pole connector configured to be electrically connected to a mating connector located in the electrical system of the aircraft. Mating connectors may comprise connections for providing power to the electrical system of the aircraft to start the aircraft engine. Mating connectors may also be used to provide power to the aircraft electrical system in order to allow various electronic devices connected to the aircraft electrical system to draw power from an external power supply such as a GPU. Such connectors frequently have control connections in addition to the power connections described above. In some applications these control connections may be used to control relays and other electrical switch devices in order to prevent power from flowing through the power connections as the GPU is connected to the aircraft. Such control is frequently accomplished through the use of one or more control connectors that are physically shorter than the power connectors. As a result of the shorter connection, the power connections may engage their mating connections before the control connection makes contact with its mating connector, resulting in the application of power to a control relay or other switch device located in the aircraft. By engaging the power connectors before closing the relay or switch, known devices may reduce the amount of arcing between power connectors and their mating connections. What is needed is a system and method for using one or more of these control connections to enable a ground power unit to mimic the mechanical behavior of such a connector during the shutdown and/or startup of the portable GPU.

The portable GPU also may comprise a charger and charger connection as described in application Ser. No. 13/750,295. The described charger receives power through a charge connection described in the application. This connection may receive power from an external source such as the electrical power system of an aircraft or a utility power source found at a ground location. Limitations on power available from the aircraft power system and also the size of the actual connections in such a charge connector may result in a relatively slow recharge of the portable GPU battery system. In certain circumstances, a more rapid recharge of the portable GPU battery may be desired. What is needed is a system and method for using one or more of the control connections in the GPU to aircraft connector to enable the rapid charging of a ground power unit.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view of a portable ground power unit according to an embodiment of the invention;

FIG. 2 is an illustration of an AN2551 type connector used in an embodiment of the invention;

FIG. 3 is a circuit diagram illustrating a connector and control circuitry in an embodiment of the invention in electrical communication with a starting device integral to an aircraft;

FIG. 4 is a circuit diagram illustrating an embodiment of the invention in electronic communication with an external power source; and

FIG. 5 is a circuit diagram illustrating a connector and control circuitry in an embodiment of the invention in electrical communication with a high-current charging source.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

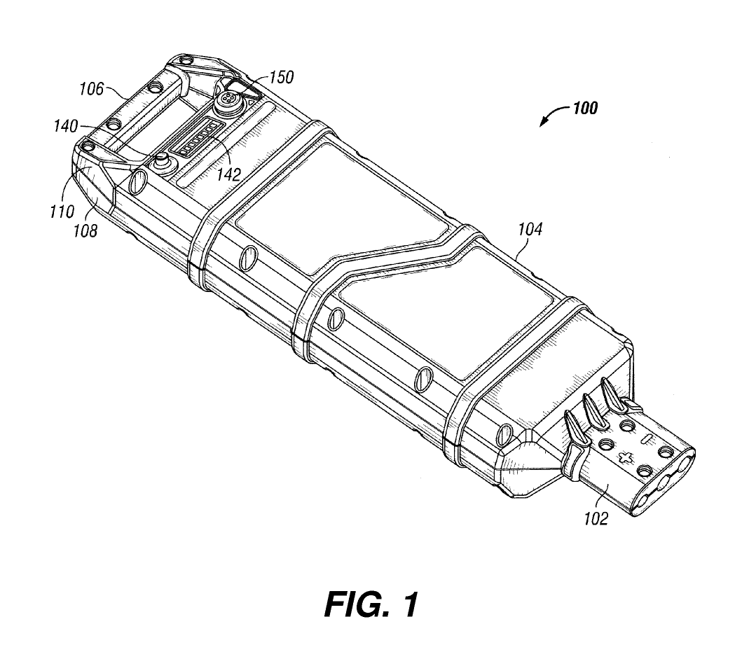

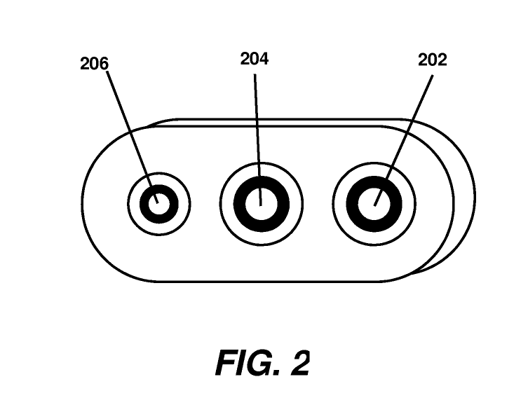

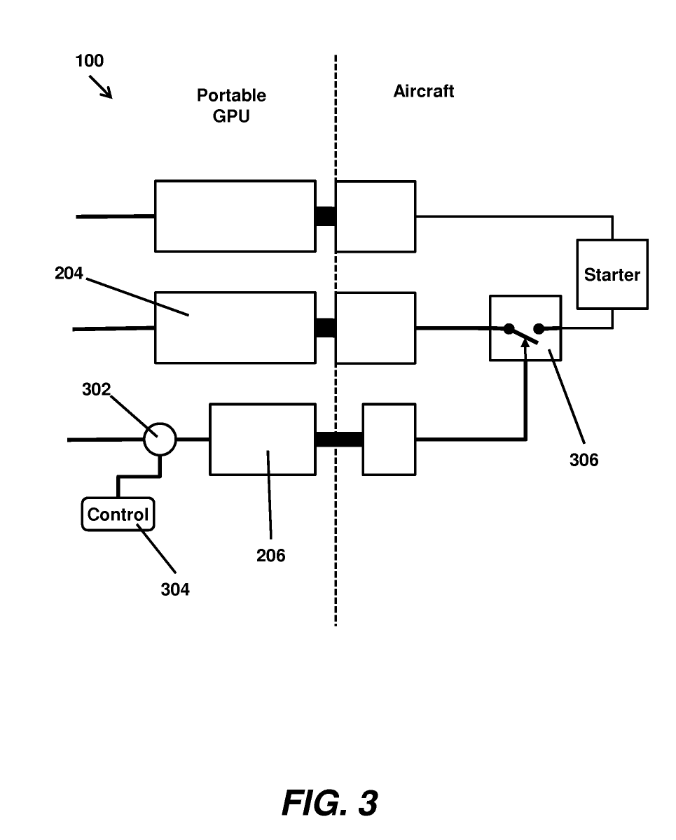

An embodiment of a portable ground power unit (GPU) 100 is illustrated in FIG. 1. Shown in the figure is an integral power connector 102, a housing 104, an integral carrying handle 106, an upper case portion 110, and a lower case portion 108. In addition to these physical features, the GPU may also comprise an on/off switch 140, a display device 142, and a charger connector 150. In an exemplary embodiment of the invention, a NATO type AN2551 connector may function as the integral power connector 102. The AN2551 connector is a universal connector used on various different aircraft applications. In such applications, an AN2552-3A, MS3506-1 or equivalent mating connector may be affixed to the aircraft and in electrical communication with the aircraft electrical system. When in use, the portable GPU integral connector may be plugged into the mating connector of the aircraft. One skilled in the art will understand that the AN2551 connector is used to illustrate the concept embodied herein and that other connector types may be used in embodiments of the invention without departing from the inventive concept described and claimed herein, where the other connector used is primarily a function of the mating connector used on the aircraft with which the GPU is to be used. Referring to FIG. 2, three connections used on the AN2551 connector are illustrated. Connection 202 is used as a “negative” electrical connection, connected to the negative pole of batteries contained within the portable GPU device. The center connector 204 is a “positive” electrical connection, connected either directly to the positive pole of a battery or connected via a control circuit that is in communication with control electronics comprised by the GPU device. The remaining connector is a control connector 206. In many GPU systems, this connection is connected to the positive electrical connection of the GPU. This control connection is positioned mechanically such that as the GPU is inserted into the mating connector of an aircraft, the positive and negative connections of the aircraft mating connector come into contact with the corresponding positive 204 and negative 202 contacts of the GPU 100 before the control contact of the aircraft makes contact with the control connection 206 of the GPU. When the control connector 206 makes electrical contact with the corresponding contact on the aircraft, a relay located in the starting circuit of the aircraft may be energized, connecting the positive and negative circuits of the GPU to the positive and negative circuits of the aircraft electrical system. Such a mechanical configuration may reduce or prevent arc damage to or welding of the positive 204 and negative 202 connectors. Referring to FIG. 3, in an embodiment of the invention, a control switch 302, which may include, but is not limited to, relays, MOSFETs, or other solid state switch devices, may be placed in electrical communication with the control connector 206. In other embodiments of the invention, the switch device 302 may be an electromechanical device such as a relay. The control switch 302 may be in electrical communication with the positive circuit of the GPU. The control switch 302 may also be in electronic communication with control circuitry 304. As the result of a control signal from the control circuitry 304, the control switch 302 may connect or disconnect, depending upon the configuration of the control switch 302, the positive GPU circuit to the control connector 206. In such an embodiment, the control circuitry 304 may thus control the signal supplied to a relay device 306 contained within an aircraft. In such embodiments of the invention, the control circuitry 304 may be used to disconnect the GPU power circuitry from the aircraft without having to physically remove the integral power connector 102 from the mating connector of the aircraft. In such an embodiment, the control circuitry will mimic the mechanical removal of the integrated power connector 102 from the aircraft mating connector. During shutdown of the GPU 100, the control connector 206 may be disconnected from the positive power source at a predetermined time before power is removed from the positive connector 204. This may have the effect of mimicking the removal of the GPU from the aircraft mating connector as the GPU shuts down.

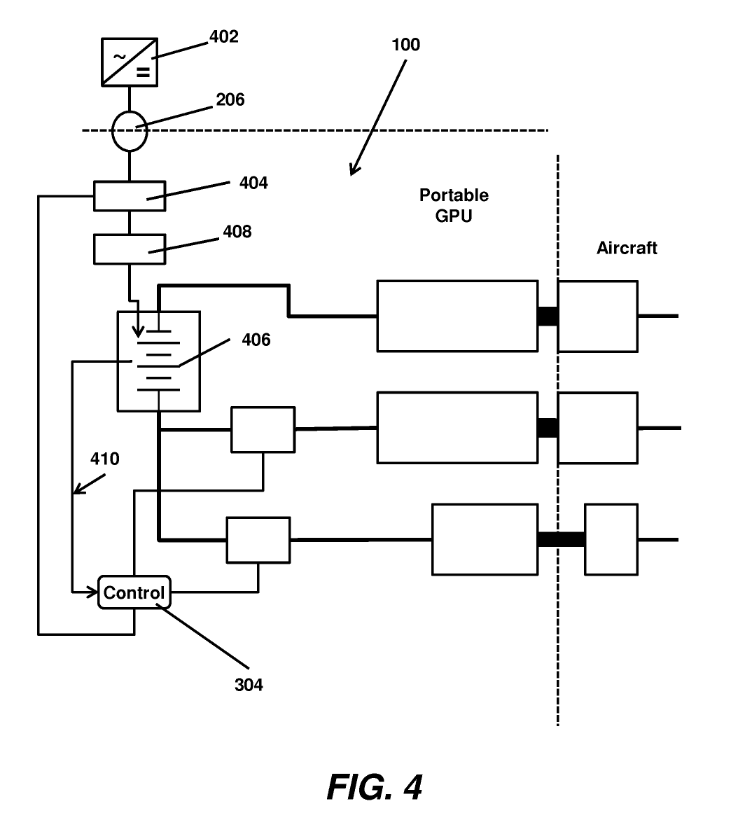

As described in U.S. patent application Ser. No. 13/750,295, embodiments of a portable GPU may comprise a charge circuit. In certain embodiments, the charge circuit may be external and be connected to the portable GPU via a charge connector (illustrated in FIG. 1 at 106). In other embodiments of the invention, the charge circuited may be located within the housing 104. As was described in application Ser. No. 13/750,295, the charge connector 150 may be used to connect the portable GPU to a power source to charge the portable GPU batteries and also provide power to aircraft electrical systems should the portable GPU power output connections be connected to the aircraft electrical system. In such embodiments, power and control circuitry may regulate power supplied by the control connector 206 when charging the GPU batteries. An example of such an embodiment is illustrated in FIG. 4. As is shown, a current charge source 402 may be connected to the control connector 206. A charge current control device such as a MOSFET or other electronic current control device 404 may be connected between the control connector 206 and the GPU battery 406. The control device 404 may be in electronic communication with the control circuitry 304 of the portable GPU 100. The control device may regulate the current supplied to the portable GPU battery 406 using pulse width modulation or linear regulation methods. Pulse width modulation is a preferred method as pulse width modulation is more efficient and thus may result in lower amounts of heat dissipation than linear regulation methods. Depending upon the method used by the control circuitry and control device 404 to regulate the charge current and voltage to the portable GPU battery, a filter circuit 408 may also be required. Such charging embodiments may utilize battery information 410 available to the control circuitry of the portable GPU to more precisely control the battery recharge characteristics. Examples of such information may include, without limitation, recharge current, battery voltage, battery temperature, and battery cell voltage. In certain embodiments of the invention, the charge circuit may be contained within the housing of the portable GPU as is illustrated in FIG. 4. In other embodiments of the invention, a charge circuit may be external to the housing of the portable GPU and provide charge current and voltage to the GPU through the charge connector 106.

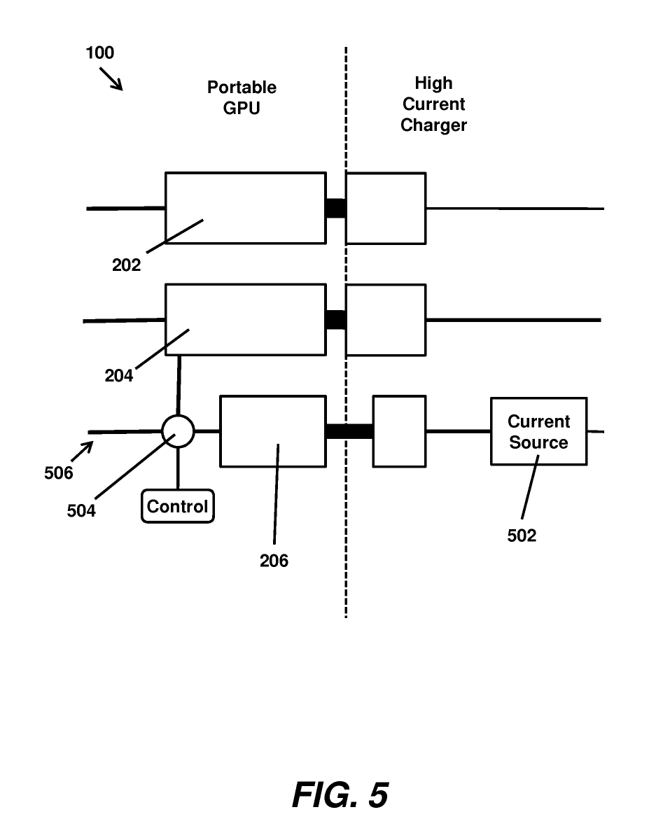

Power levels able to be received from external sources using the charge connector 106 may be limited by the current capability of the connector contacts or the external source of current applied. In some circumstances it may be desired that a GPU battery system receive a higher rate of charge than can be provided using the charge connector. As is illustrated in FIG. 5, in certain embodiments of the invention, the control connector 206 may be configured to receive battery recharge power from a source capable of providing a high charge current 502. In an example of such an embodiment, a portable GPU 100 may be placed in electrical connection with a charging power source 502 that provides a charge current using the control connector 206 and negative connector 202. In such an embodiment, the charging power source 502 may control the charge characteristics such that the current and voltage provided to the GPU battery system are regulated by the charging power source to provide an acceptable charge curve to the GPU battery system. Such systems may utilize battery information available from the positive power connector 204 and the charge connector 106. Such information may include, but is not limited to, battery voltage, battery charge current, battery temperature, and battery cell voltages. Other embodiments may perform the current regulation internally to the GPU. In such an embodiment, a control circuit 504 integral to the GPU may regulate the charge current 506 to the GPU battery.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A portable aircraft ground power system comprising:
a housing;
a battery disposed in said housing;
a first connector integral to said housing, said first connector sized and adapted to enable it to be inserted into and be in electrical communication with a ground power connector of an aircraft; and
a control circuit disposed in said housing and in electrical communication with said connector where such control circuit further comprises:
a current regulating device in electrical communication with said battery and said first connector; and
electronic circuitry in communication with said current regulating device which is designed and adapted to regulate a charging current flowing from said connector to said battery.

2. The system of claim 1, wherein said first connector comprises a negative connection, a positive connection, and a control connection.

3. The system of claim 2, wherein said charging current flowing from said connector is provided by said control connection.

4. The system of claim 2, wherein said charging current flowing from said connector is provided by said positive connection.

5. The system of claim 1, wherein said electronic circuitry comprises circuits which enable at least two selectable current limit set points.

6. The system of claim 1, also comprising a display device disposed in said housing and in electronic communication with said control circuit, where said display is adapted to display a representation of said current flowing from said connector to said battery.

7. The system of claim 1, wherein said battery comprises a plurality of lithium ion cells.

8. A system for providing power to an aircraft electrical system comprising:
A portable aircraft ground power system further comprising:
a housing;
a battery disposed in said housing;
a first connector integral to said housing, said first connector sized and adapted to mate with a ground power input connector of said aircraft electrical system, said first connector in electrical communication with said battery;
a second connector mounted to said housing; and
a control circuit in electrical communication with said battery, said control circuit comprising:
a regulating circuit in electrical communication with said second connector, said regulating circuit configured to regulate a battery charging current flowing from said second connector to said battery, said regulating circuit also in electrical communication with said first connector and configured to provide a regulated voltage to said first connector.

9. The system of claim 8, wherein said regulating circuit is disposed within said housing.

10. The system of claim 8, wherein said control circuit comprises circuits which enable at least two selectable current limit set points.

11. The system of claim 8, wherein said regulating circuit receives electrical current from a source located externally from said enclosure and additionally comprises circuitry adapted to limit the received electrical current.

12. The system of claim 8, also comprising a display device disposed in said housing and in electronic communication with said control circuit, where said display is adapted to display a representation of said battery charging current.

13. The system of claim 8, wherein said battery comprises a plurality of lithium ion cells.

14. A portable aircraft ground power system comprising:
a housing;
a battery disposed in said housing;
a first connector integral to said housing, said first connector sized and adapted to enable it to be inserted into and be in electrical communication with a ground power connector of an aircraft;
a second connector mounted to said housing;
a control circuit disposed in said housing and in electrical communication with said first and second connectors where such control circuit further comprises:
a current regulating device in electrical communication with said battery and said first connector; and
electronic circuitry in communication with said current regulating device which is designed and adapted to regulate a charging current flowing from said first connector to said battery; and
a regulating circuit in electrical communication with said second connector, said regulating circuit configured to regulate a battery charging current flowing from said second connector to said battery, said regulating circuit also in electrical communication with said first connector and configured to provide a regulated voltage to said first connector.

15. The system of claim 14, wherein said regulating circuit is disposed within said housing.

16. The system of claim 14, wherein said regulating circuit receives electrical current from a source located externally from said enclosure and additionally comprises circuitry adapted to limit the received electrical current.

17. The system of claim 14, wherein said battery comprises a plurality of lithium ion cells.

18. The system of claim 14, also comprising a display device disposed in said housing and in electronic communication with said control circuit, where said display is adapted to display a representation of said battery charging current.

19. The system of claim 14, wherein said control circuit comprises circuits which enable at least two selectable current limit set points.
